(19) United States
(12) Patent Application Publication
(10) Pub. No.: US 2012/0124473 A1
(43) Pub. Date: May 17, 2012

(54) SYSTEM AND METHOD FOR PLAYING MUSIC USING MUSIC VISUALIZATION TECHNIQUE

(75) Inventors: Sungmin KIM, Daejeon (KR); Seungjae Lee, Daejeon (KR); JungHyun Kim, Daejeon (KR); Young Ho Suh, Daejeon (KR); Yong-Seok Seo, Daejeon (KR); Jee Hyun Park, Daejeon (KR); Sang Kwang Lee, Daejeon (KR); Jung Ho Lee, Daejeon (KR); Young-Suk Yoon, Daejeon (KR); Wonyoung Yoo, Daejeon (KR)

(73) Assignee: ELECTRONICS AND TELECOMMUNICATIONS RESEARCH INSTITUTE, Daejeon (KR)

(21) Appl. No.: 13/293,596

(22) Filed: Nov. 10, 2011

(30) Foreign Application Priority Data
Nov. 12, 2010 (KR) 10-2010-0112730

(51) Int. Cl. G06F 3/01

(52) U.S. Cl. 715/716

(57) ABSTRACT

A music playing system using a music visualization technique includes: a music information extraction unit for extracting one or more pieces of music information regarding basic characteristics, meta-characteristics and emotional characteristics of music, the music including music being played at present, music selected for playing, and music selected for visualization; and a display control unit that provides a user interface window for visualizing the extracted music information and controls the user interface window, wherein the user interface window includes a visualization configuration panel having a setup function for selecting the music information to be extracted.

### CROSS-REFERENCE(S) TO RELATED APPLICATION(S)

The present invention claims priority of Korean Patent Application No. 10-2010-0112730, filed on Nov. 12, 2010, which is incorporated herein by reference.

### FIELD OF THE INVENTION

The present invention relates to playing music; and, more particularly, to a system and method for playing music which can play or recommend music based on a music visualization technique.

### BACKGROUND OF THE INVENTION

In recent years, accessibility to music has remarkably been improved with the use of digital music, so that the amount of music which is accessible by the general users aside from specialists has been exponentially increased.

Although the amount of music available to the public has sharply grown through commercialization of digital music, the lack of music information is still making it difficult for users to choose the right music for themselves. It is not easy to search for music without any information on music, and besides, it is no wonder that one-sided recommendations by a few specialists cannot satisfy a number of people perfectly. Accordingly, a music recommendation system has been developed and introduced, which enables users to search their desired music or get recommendations of not knowing music. Through this system, ordinary users have been able to access a variety of music by their own selections.

The users, however, still have a difficulty in searching music and getting recommendations through the music recommendation system, so that various methods for visually representing music have been developed. Among them, a method of simply visualizing music converted into electric signals by using the signals' magnitudes and a method of visualizing the magnitude of volume by using colors have a disadvantage in that the users cannot see various music information visually. Further, a method of visualizing various music information is so complicated that it cannot easily draw users' understanding.

Therefore, there is a need for studies on visualizing music so that users easily understand music information to thereby search desired music.

### SUMMARY OF THE INVENTION

In view of the above, the present invention provides a system and method for playing music using a music visualization technique, which enables users to easily understand various characteristics of music and to search desired music.

In accordance with a first aspect of the present invention, there is provided a music playing system using a music visualization technique, including:

a music information extraction unit for extracting one or more pieces of music information regarding basic characteristics, meta-characteristics and emotional characteristics of music, the music including music being played at present, music selected for playing, and music selected for visualization; and

a display control unit that provides a user interface window for visualizing the extracted music information and controls the user interface window,

wherein the user interface window includes a visualization configuration panel having a setup function for selecting the music information to be extracted.

In accordance with a second aspect of the present invention, there is provided a music playing method using a music visualization technique, including:

selecting at least one kind of music information regarding basic characteristics, meta-characteristics and emotional characteristics of music, the music including music being played at present, music selected for playing, and music selected for visualization;

extracting the selected music information; and

visualizing the extracted music information to display.

### BRIEF DESCRIPTION OF THE DRAWINGS

The objects and features of the present invention will become apparent from the following description of embodiments, given in conjunction with the accompanying drawings, in which:

FIG. 1 is a block diagram showing a music playing system using a music visualization technique in accordance with an embodiment of the present invention.

FIG. 2 illustrates a user interface window provided in a display apparatus shown in FIG. 1.

FIG. 3 depicts an exemplary configuration of a visualization configuration panel shown in FIG. 2.

FIGS. 4A and 4B depict examples of visualizing genres as music information.

FIG. 4C illustrates an example of visualizing an AV plane as music information for selected music (or a playlist).

FIG. 4D shows an example of visualizing an emotion plane as music information for selected music (or a playlist).

FIG. 4E shows an example of visualizing year released by artist as music information for selected music (or a playlist).

FIG. 4F shows an example of visualizing genre by artist as music information for selected music (or a playlist).

FIG. 5 illustrates an exemplary playlist displayed on a playlist window shown in FIG. 2.

### DETAILED DESCRIPTION OF THE EMBODIMENTS

Hereinafter, embodiments of the present invention will be described with reference to the accompanying drawings which form a part hereof.

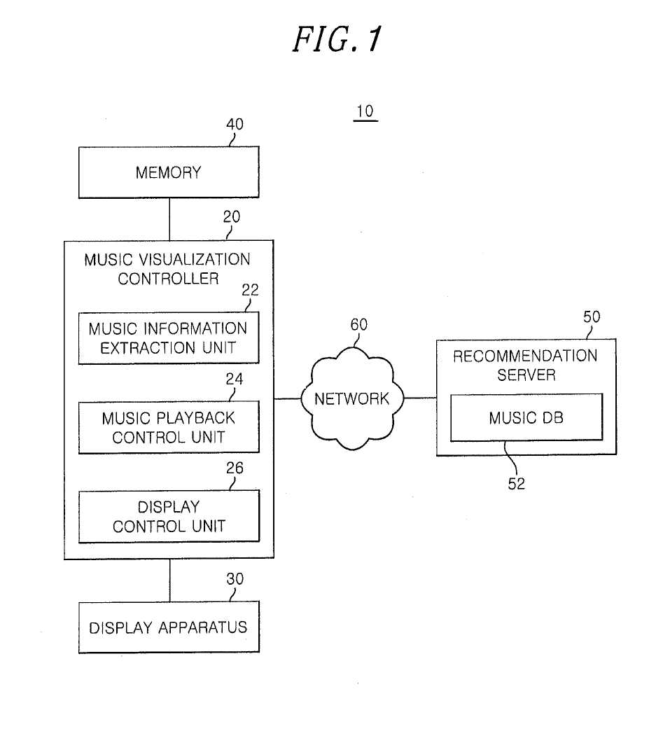

FIG. 1 is a block diagram showing a music playing system using a music visualization technique in accordance with an embodiment of the present invention.

The music playing system 10 includes a music visualization controller 20, a display apparatus 30 and a memory 40. Further, a recommendation server 50 may be included.

The memory 40 stores various music and related information thereof. The related music information includes basic characteristics, meta-characteristics and emotional characteristics, which will be described later.

The music visualization controller 20 includes a music information extraction unit 22, a music playback control unit 24, and a display control unit 26 and is connected to the recommendation server 50 via a network 60.

The recommendation server 50 contains a music database (DB) 52 and searches the music DB 52 for music to recommend based on received music information upon request from the music visualization controller 20. The searched music is delivered to the music visualization controller 20.

The music information extraction unit 22 in the music visualization controller 20, in response to a user's request, extracts an album jacket contained as meta information in the music being played at present. Alternatively, the music information extraction unit 22 accesses the recommendation server 50 via the network 60 to obtain the album jacket from it.

Further, the music information extraction unit 22 extracts, from the memory 40, music information on several pieces of music including music being played at present, music selected for playing, and music selected for visualization. If the music information does not exist in the memory 40, it can be extracted from the recommendation server 50. The extracted music information is delivered to the display control unit 26.

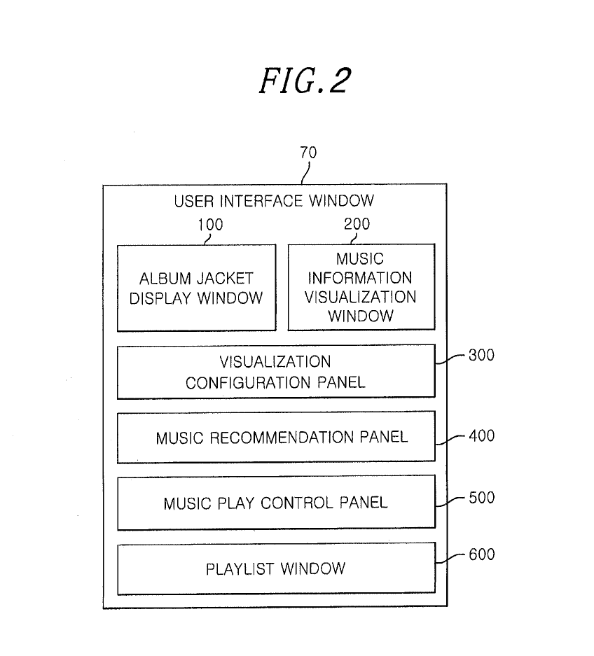

The music playback control unit 24 controls audio play by a user's request. When receiving the user's request such as playing music in a playlist, pausing the music, performing fast forward and the like, the music playback control unit 24 performs a corresponding control. Further, the music playback control unit 24 has a function of recommending music to thereby allow a user to easily search for music and receive a recommendation. The recommended music is displayed on a user interface window 70, which is shown in FIG. 2, of the display apparatus 30 by the display control unit 26.

The display control unit 26 provides the display apparatus 30 with the user interface window 70 for visualizing music-related information and controls the user interface window 70 in response to a user's input. The music-related information contains the album jacket and the music information extracted by the music information extraction unit 22.

Referring to FIG. 2, the user interface window 70 includes an album jacket display window 100, a music information visualization window 200, a visualization configuration panel 300, a music recommendation panel 400, a music play control panel 500 and a playlist window 600.

The album jacket of music being played at present, which is extracted by the music information extraction unit 22, is visualized and displayed on the album jacket display window 100.

The music information extracted by the music information extraction unit 22 is visualized and displayed on the music information visualization window 200.

The music information displayed on the music information visualization window 200 helps a user more easily understand music, retrieve music, and receive a recommendation.

Here, the basic characteristics, meta-characteristics, emotional characteristics of the music which are utilized as music information may be defined as follows.

The basic characteristics of music include a mode or a key, a tempo, an instrument, a harmony and the like.

The meta-characteristics of music represent semantic characteristics of the music, which include artist, composer, year released, album name, band type, artist's gender, album release type, genre or style, presence/absence of original music, playcount and the like. Herein, the band type is classified into one-man band, duo, trio, band, orchestra and the like, and the album release type into a single, a formal album, a project album, a tribute album and the like. The genre or style includes classic, rock, hip hop, pop and the like. The presence/absence of original music represents whether it is an original or a remake. The playcount denotes how many times the same music has been played in the music playing system 10.

The emotional characteristics of music represent feelings that the music express or emotions that users (listeners) feel, and may include an emotion expression value, AV (arousal/valence) model value, and the like. Herein, the emotion expression value expresses a general emotion such as pleasant, sad, happy, vibrant, and the like which can be felt through the music, according to a music adjective emotion model. The AV model value means an AV value of the music determined through a two-dimensional AV music emotion model.

The above-described music information is displayed on the music information visualization window 200 by using a two-dimensional visualization technique with a variable axis. That is, the music information visualization window 200 provides a user with correlated combined information between individual music information by using an x-axis and y-axis of a two-dimensional plane. For example, one-dimensional text information such as genre or artist of the music being played can be provided, or two-dimensional value such as the emotion expression value or the AV value of the music can be provided. Moreover, correlated combined information between one-dimensional music information such as genre by artist, year released by artist and the like can be provided.

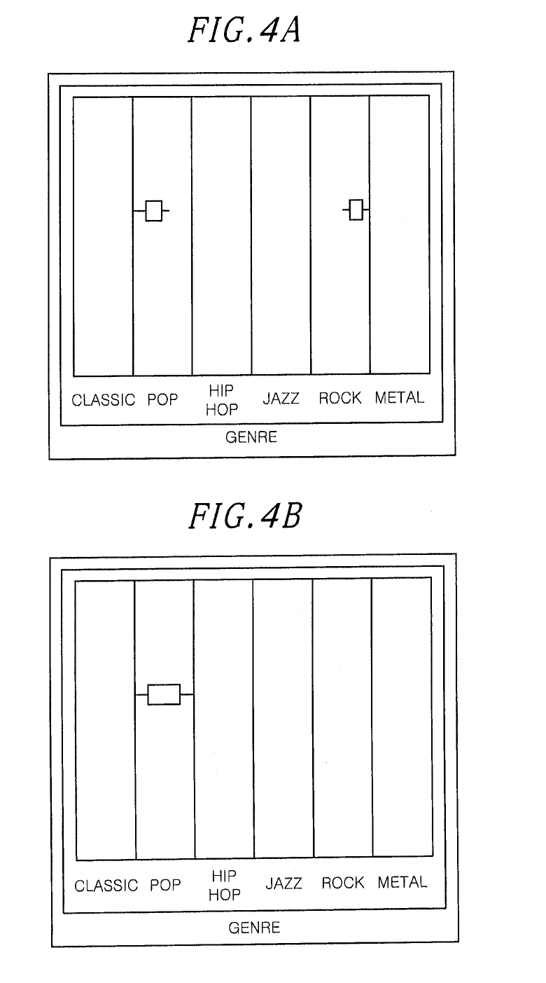

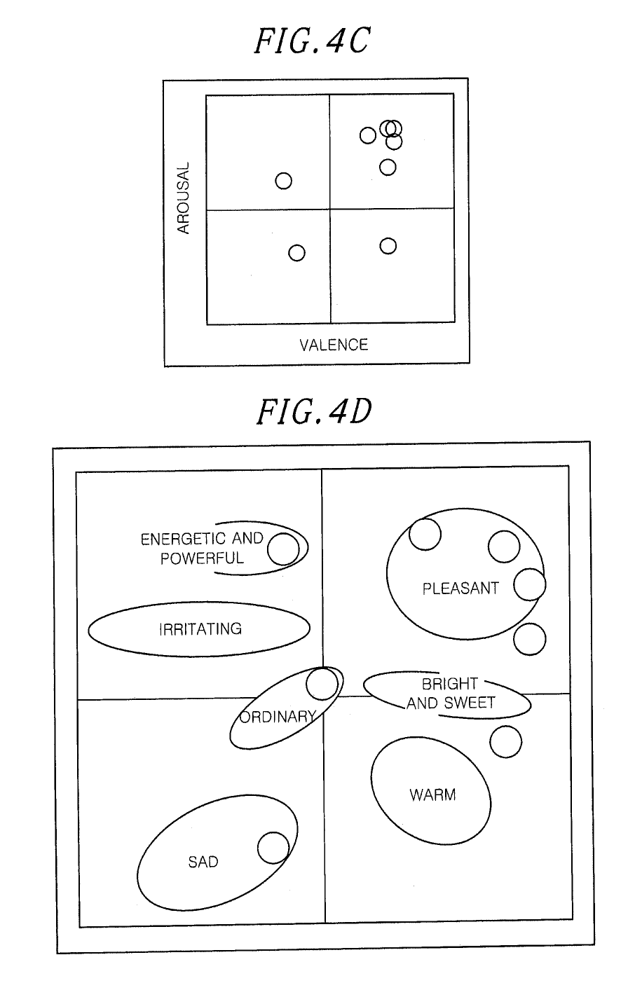

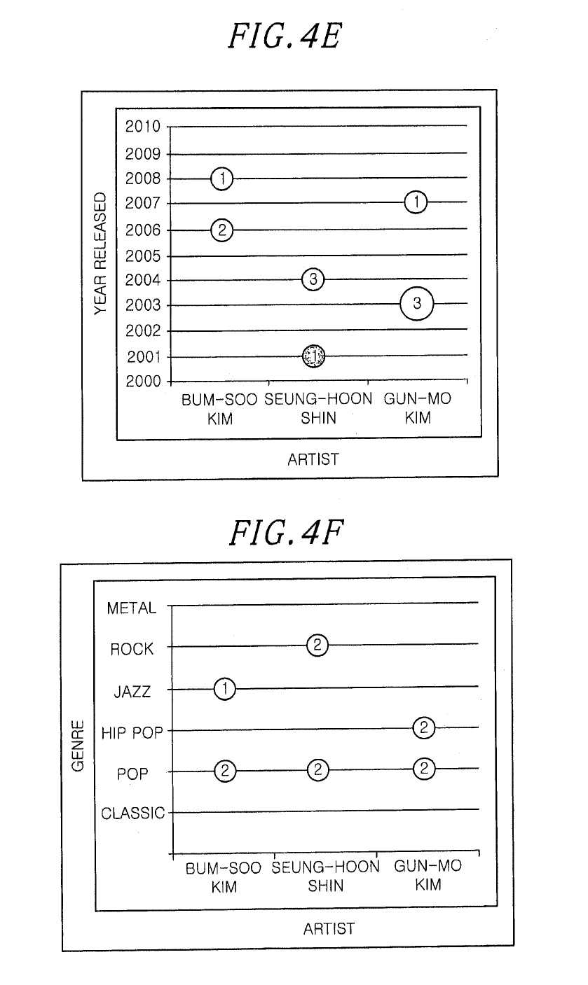

Various examples of visualizing the music information on the music information visualization window 200 according to the music information of the x-axis and the y-axis are shown in FIGS. 4A to 4F.

FIGS. 4A and 4B depict examples of visualizing genres as the music information. In FIG. 4A, pop and rock in genre exist mixed together in selected music (or a playlist), and in FIG. 4B, all genres are pop. In these examples, each genre's portion may be known by the lengths of horizontal bars.

FIG. 4C illustrates an example of visualizing an AV plane as the music information for selected music (or a playlist). FIG. 4D shows an example of visualizing an emotion plane as the music information for selected music (or a playlist). In the AV plane and the emotion plane, corresponding information of the selected music may be known by locations of circle marks.

FIG. 4E shows an example of visualizing year released by artist as the music information for selected music (or a playlist). Referring to FIG. 4E, if one artist releases a plurality of music in a year, in order to express the plurality of music, the number of music can be provided inside of the same shape, or gradations of color can be used. Further, a size of the shape or a size of the number of music written inside of the shape can be adjusted for the same purpose.

FIG. 4F shows an example of visualizing genre by artist as the music information for selected music (or a playlist). Although a figure is provided inside of the same shape in order to express the number of music with the same genre released by one artist in FIG. 4F, different ways may be used to show the number of music as in FIG. 4E.

Display of the music information using the two-dimensional visualization technique with a variable axis may vary depending on music information provided by the music playing system 10, other than the examples shown in FIGS. 4A to 4F. The music information provided by the music playing system 10 can be a part or an expanded one of the music information proposed in the embodiment of the present invention or other information.

To use the correlated combined information between one-dimensional music information, the music information needs to be set for the x-axis and the y-axis, and this setup can be done by the visualization configuration panel 300.

That is, the x-axis and the y-axis may be set as the music information, which is visualizable and desired by a user, by the setup function of the visualization configuration panel 300. Therefore, a variety of music information can be selectively displayed on a two-dimensional x-y plane.

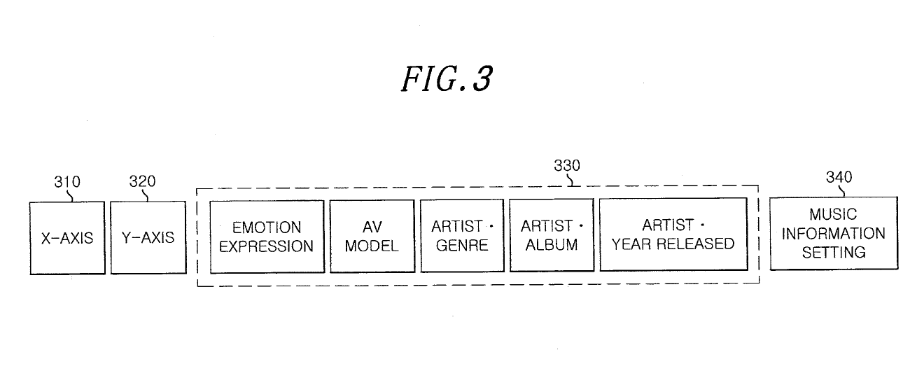

The visualization configuration panel 300, which is shown in FIG. 3, provides several basic menu buttons 330 for providing music information which is generally in frequent use among one-dimensional music information, two-dimensional music information, and two-dimensional correlated combined information between one-dimensional music information. The basic menu buttons 330 may be made and provided with user-desired information by the user. Examples of the correlated combined information may include artist-genre, artist-album, artist-year released, and the like.

The visualization configuration panel 300 further provides an ‘x-axis’ button 310 and a ‘y-axis’ button 320 so that the user can choose the music information to be displayed by using the buttons 310 and 320.

The music information assigned to such buttons shown in FIG. 3 can be reconfigured depending on a user's preference by using a ‘music information setting’ button 340.

The display control unit 26 visualizes the music information in accordance with a user's setting inputted from the visualization configuration panel 300 and displays the visualized music information on the music information visualization window 200. For example, the display control unit 26 may visualize and display one-dimensional text information such as genre or artist of the music being played at present, or two-dimensional value such as the emotion expression value or the AV value of the music. Moreover, correlated combined information between one-dimensional music information such as genre by artist, year released by artist and the like can be displayed on the music information visualization window 200.

The music recommendation panel 400 provides an interface that enables a user to easily search desired music and receive a recommendation.

When the user requests a search of desired music or requests a recommendation list, music information to be set as a search condition may be selected through the music recommendation panel 400. The music playback control unit 24 in the music visualization controller 20 searches the memory 40 or the recommendation server 50 connected via the network 60 based on the search condition, i.e., the selected music information. The searched music for recommendation is visually displayed on the playlist window 600.

In the music playing system 10 in accordance with the present invention, the situation where the music playback control unit 24 searches for user-desired music or recommends music can be made in three assumptions as follows:

First, when a user wants another music while listening to one possessed by him/her, music playback control unit 24 can retrieve or recommend music from the memory 40 or the recommendation server 50, based on various music information, e.g., mode, tempo, instrument, artist, composer, year released, album, emotion expression value, and/or AV value, regarding the music that the user is listening to.

Second, when a user requests music that he/she possesses but has not listened to due to a lack of the music's information, the music playback control unit 24 can retrieve or recommend music from the memory 40 or from the recommendation server 50, based on specific music information, e.g., mode, tempo, instrument, artist, composer, year released, album, emotion expression value, and/or AV value.

Lastly, when a user wants music that does not belong to him/her, the music playback control unit 24 can retrieve or recommend music by way of the recommendation server 50 based on specific music information, e.g., mode, tempo, instrument, artist, composer, year released, album, emotion expression value, and/or AV value.

In the above, although three situations has been assumed in accordance with the embodiment of the present invention, music desired by the user can be searched or recommended depending on individual scenarios based on the music information by situation. Further, other than the music information mentioned above, all available music information can be used to retrieve music or receive a recommendation.

The music play control panel 500 provides an interface through which a user can operate audio play such as playing music in a playlist, pausing the music, performing fast forward and the like.

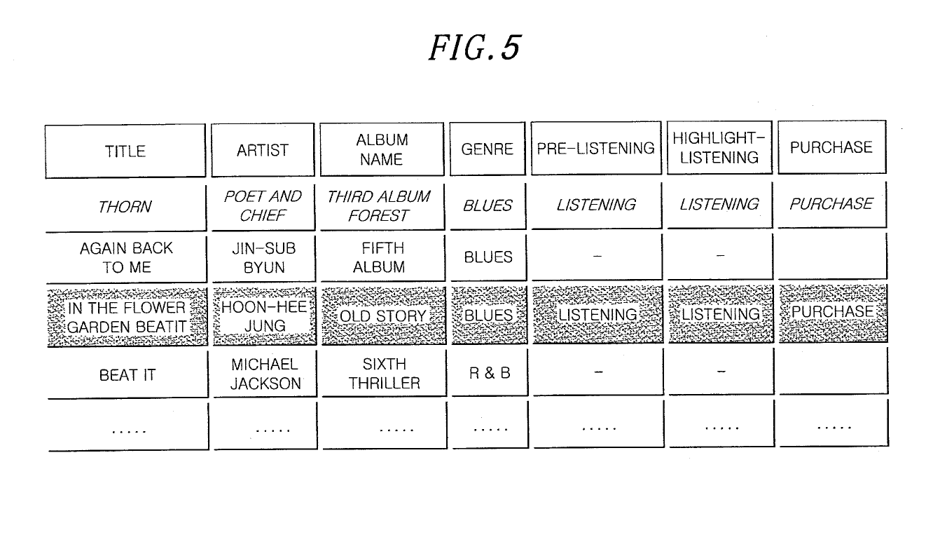

When the searched music or the recommended music is displayed on the playlist window 600, it is classified by the display control unit 26 according to whether it exists in a local device (i.e., in the memory 40) or in the music DB 52 within the recommendation server 50 and it is displayed with the classification result. In other words, the playlist window 600 provides a playlist which distinguishes free music from paid music, as shown in FIG. 5.

FIG. 5 shows an exemplary playlist displayed on the playlist window.

Referring to FIG. 5, a plurality of menus in the playlist may include title, artist, album name, genre, pre-listening, and highlight-listening, and may be changed depending on music information provided by the music playing system 10. When a user clicks a tab of the ‘title’, the playlist may be arranged according to the title.

Whether the music is provided from a local device (i.e., the memory 40) or from the recommendation server 50 (i.e., the music database 52) can be clarified by exhibiting the ‘pre-listening’ and ‘highlight-listening’ menu. Also, the music from the local device can be distinguished from the music provided from the recommendation server 50 by a font or a shadow, of which example is shown in the first and third row in the playlist. The music information of the first row is being displayed in italic font and the music information of the third row is being displayed with a shadow in background, unlike other rows. Above this, to distinguish between the music from the recommendation server 50 and the music from the local device, various methods, e.g., color change of text or gradation technique may be used.

Users can purchase the music from the recommendation server 50 through a ‘purchase’ tab, after pre-listening or highlight-listening a part of the music by using the corresponding tab. Further, it is possible to directly retrieve music or receive a recommendation list on the playlist window 600 by using specific information on the playlist, without using the interface provided by the music recommendation panel 400.

As described above, the present invention provides a music visualization technique which can improve comprehension by users of music by providing various music information such as basic characteristics, meta-characteristics, and emotional characteristics of the music. Through the music visualization technique, the users can retrieve or receive a recommendation list of music which is inaccessible to themselves because they do not possess or know.

Further, the present invention involves the possibilities of selecting various neglected music that have rarely been exposed to the media such as the news media, image media and internet media where music-related information is provided but that have popular appeal or can lead a new trend. Therefore, the present invention contributes to the expansion and development of digital music market even when viewed from the side of the users as well as from the music itself, by providing a system and a method for playing music which can play or recommend music based on the music visualization technique.

While the invention has been shown and described with respect to the embodiments, it will be understood by those skilled in the art that various changes and modification may be made without departing from the scope of the invention as defined in the following claims.

What is claimed is:

1. A music playing system using a music visualization technique, comprising:
a music information extraction unit for extracting one or more pieces of music information regarding basic characteristics, meta-characteristics and emotional characteristics of music, the music including music being played at present, music selected for playing, and music selected for visualization; and
a display control unit that provides a user interface window for visualizing the extracted music information and controls the user interface window,
wherein the user interface window includes a visualization configuration panel having a setup function for selecting the music information to be extracted.

2. The music playing system of claim 1, wherein the display control unit visualizes the extracted music information on the user interface window by using a two-dimensional plane with a variable axis.

3. The music playing system of claim 1, wherein the display control unit visualizes correlated combined information between the extracted music information on a two-dimensional plane on the user interface window.

4. The music playing system of claim 1, wherein the visualization configuration panel provides at least two buttons, each button being employed to display one piece of the music information.

5. The music playing system of claim 1, wherein the visualization configuration panel provides one or more buttons, each button being employed to display correlated combined information of two among the music information.

6. The music playing system of claim 1, wherein the visualization configuration panel provides an interface for generating correlated combined information by selecting two among the music information.

7. The music playing system of claim 1, further comprising:
a music playback control unit for recommending music provided in a local device, based on the music information.

8. The music playing system of claim 1, further comprising:
a music playback control unit for remotely receiving recommended music from a recommendation server connected via a network, based on the music information.

9. A music playing method using a music visualization technique, comprising:
selecting at least one kind of music information regarding basic characteristics, meta-characteristics and emotional characteristics of music, the music including music being played at present, music selected for playing, and music selected for visualization;
extracting the selected music information; and
visualizing the extracted music information to display.

10. The music playing method of claim 9, wherein the extracted music information is displayed on a two-dimensional plane with a variable axis.

11. The music playing method of claim 9, wherein when two pieces of the music information is selected, correlated combined information of the two pieces of the music information is displayed on a two-dimensional plane.

12. The music playing method of claim 9, further comprising:
retrieving and providing recommendation music suitable for a user based on the extracted music information.

13. The music playing method of claim 12, wherein the recommendation music is retrieved from a recommendation server connected via a network, based on the extracted music information.

14. The music playing method of claim 12, wherein the recommendation music is retrieved in a local device based on the extracted music information.
